(19) United States
(12) Patent Application Publication
(10) Pub. No.: US 2023/0058863 A1
(43) Pub. Date: Feb. 23, 2023

(54) COUNTERMEASURES AGAINST SIDE-CHANNEL ATTACKS ON SECURE ENCRYPTED VIRTUALIZATION (SEV)-SECURE NESTED PAGING (SEV-SNP) PROCESSORS

(71) Applicant: Baidu USA, LLC, Sunnyvale, CA (US)

(72) Inventors: Huibo WANG, Milpitas, CA (US); Kang LI, Santa Clara, CA (US); Mengyuan LI, Columbus, OH (US); Yueqiang CHENG, San Jose, CA (US)

(73) Assignee: Baidu USA LLC, Sunnyvale, CA (US)

(21) Appl. No.: 17/715,858

(22) Filed: Apr. 7, 2022

Related U.S. Application Data
(60) Provisional application No. 63/231,716, filed on Aug. 10, 2021.

(51) Int. Cl. G06F 21/62

(52) U.S. Cl. CPC G06F 21/62

(57) ABSTRACT

AMD's Secure Encrypted Virtualization (SEV) is a hardware extension available in AMD's EPYC™ server processors to support confidential cloud computing. Although known attacks against SEV, which exploit its lack of encryption in the virtual machine (VM) control block or the lack of integrity protection of the encrypted memory and nested page tables, have been addressed in subsequent releases of SEV-Encrypted State (SEV-ES) and SEV-Secure Nested Paging (SEV-SNP), a new CipherLeaks attack presents a previously unexplored vulnerability for SEV-ES and SEV-SNP. The attack allows a privileged adversary to infer a guest VM's execution states or recover certain plaintext, e.g., to steal private keys from the constant-time implementation of the Rivest-Shamir-Adleman (RSA) algorithm and the Elliptic Curve Digital Signature Algorithm (ECDSA) in the latest OpenSSL library.

### CROSS-REFERENCE TO RELATED APPLICATION(S)

This patent application is related to and claims priority benefit under 35 USC § 119(e) to co-pending and commonly-owned U.S. Pat. App. No. 63/231,716, filed on Aug. 10, 2021, entitled “Breaking Constant-time Cryptography on AMD SEV via the Ciphertext Side Channel,” and listing Mengyuan Li, Yinqian Zhang, Huibo Wang, Kang Li, and Yueqiang Cheng as inventors (Docket No. 28888-2531P), which patent document is incorporated by reference herein in its entirety and for all purposes.

### COPYRIGHT NOTICE

A portion of the disclosure in this patent document contains material that is subject to copyright protection. The copyright owner has no objection to the facsimile reproduction by anyone of the patent document, as it appears in the Patent and Trademark Office patent file or records, but otherwise reserves all copyright rights.

### BACKGROUND

### A. Technical Field

The present disclosure relates generally to virtualization security features in applications such as confidential cloud computing. More particularly, the present disclosure relates to attacks on memory integrity of SEV processors, such as side-channel attacks by an untrusted hypervisor that are designed to breach the memory encryption of guest VMs, and countermeasures to protect VMs against such attacks.

### B. Background

Recent releases of SEV-ES and SEV-Secure Nested Paging (SEV-SNP) shield against attacks that seek to exploit a lack of encryption in the virtual machine control block (VMCB) or the lack of integrity protection of the encrypted memory and nested page tables. To enhance confidential cloud computing, it would be desirable explore other existing vulnerabilities of SEV, including SEV-ES and SEV-SNP, e.g., those that may allow a privileged adversary to infer a guest VM's execution states or recover certain plaintext, and have countermeasures against such vulnerabilities.

### BRIEF DESCRIPTION OF THE DRAWINGS

References will be made to embodiments of the disclosure, examples of which may be illustrated in the accompanying figures. These figures are intended to be illustrative, not limiting. Although the disclosure is generally described in the context of nested page table embodiments, it should be understood that it is not intended to limit the scope of the disclosure to these particular embodiments as any suitable page table structure or scheme may be employed. For example, additional levels of translation, caching operations, and the like may be incorporated to achieve the objectives of the present disclosure.

Figure (“FIG.”) 1A and FIG. 1B depict exemplary ciphertext changes in nested page faults (NPFs), according to embodiments of the present disclosure.

FIG. 2A and FIG. 2B depict workflow of a virtual memory manager (VMM) Communication Exception (VC) handler handling IOIO_PROT events, according to embodiments of the present disclosure.

FIG. 3 depicts various Non-Automatic VM Exit (NAE) events observed during a boot period and exemplary register state ranges that may be exposed, according to embodiments of the present disclosure.

FIG. 4A and FIG. 4B depict an exemplary distribution of Advanced Programmable Interrupt Controller (APIC) interrupts and respective deltas, according to embodiments of the present disclosure.

FIG. 5 is a flowchart illustrating a method for exploiting vulnerabilities in Secure Encrypted Virtualization (SEV), according to embodiments of the present disclosure.

FIG. 6 is a flowchart illustrating a method for protecting against attacks by a compromised hypervisor, according to embodiments of the present disclosure.

FIG. 7 is a flowchart illustrating a method for reducing leakage of confidential information from guest VM registers, according to embodiments of the present disclosure.

FIG. 8 depicts a Reverse Map Table (RMP) check as used in various embodiments of the present disclosure.

FIG. 9 depicts a simplified block diagram of a computing device/information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system, a device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgment, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. The terms “include,” “including,” “comprise,” “comprising,” or any of their variants shall be understood to be open terms, and any lists of items that follow are example items and not meant to be limited to the listed items. A “layer” may comprise one or more operations. The use of memory, database, information base, data store, tables, hardware, cache, and the like may be used herein to refer to system component or components into which information may be entered or otherwise recorded. A set may contain any number of elements, including the empty set.

Any headings used herein are for organizational purposes only and shall not be used to limit the scope of the description or the claims. Each reference/document mentioned in this patent document is incorporated by reference herein in its entirety.

It shall be noted that any experiments and results provided herein are provided by way of illustration and were performed under specific conditions using a specific embodiment or embodiments; accordingly, neither these experiments nor their results shall be used to limit the scope of the disclosure of the current patent document.

It is noted that although embodiments described herein may be within the context of software-based side channel attacks, aspects of the present disclosure are not so limited. Accordingly, aspects of the present disclosure may be applied or adapted for use in hardware-based attacks, including side channel attacks, and other contexts.

In this document, the term “page walk” and “page table walk” are used interchangeably. Similarly, the terms “system physical address” and “host physical address;” “host” and “system;” and “host OS” and “system OS” may be used interchangeably. The term “guest” refers to any operating system that is virtualized, and the term “hypervisor” refers to any platform layer the decouples an operating system from its underlying hardware. A “nested page table” refers to a page table that comprises a translation from a guest physical address to a system physical address or host physical address.

A. General Introduction

Advanced Micro Devices' (AMD's) SEV is an extension of the AMD Virtualization (AMD-V) technology. It provides security features, such as memory encryption and isolation to virtual machines (VMs), in order to support scenarios like confidential cloud computing where hypervisors are not trusted to respect the security of VMs.

However, with the assumption of a malicious hypervisor, SEV faces numerous attacks. One vulnerability of SEV lies in the VMCB not being encrypted during the world switch between the guest VM and the hypervisor, which enables the hypervisor to inspect and/or alter the control flow of the victim VM. AMD thus released SEV-ES, the second generation of SEV that encrypts the sensitive portions of the VMCB and stores them into the VM Save Area (VMSA) during the world switch. Therefore, these attacks can be mitigated.

However, other vulnerabilities of SEV, including an unprotected nested page table (NPT), unauthenticated encryption, and unprotected I/O and unauthorized Address Space identifiers (ASIDs) have been demonstrated to threaten the security of SEV-ES. To perform such attacks, the hypervisor must alter the encrypted memory or the physical address mapping of the victim VM. This is possible because SEV does not have sufficient protection for memory integrity. To tackle these issues, AMD has announced the release of SEV-SNP for its next generation of SEV processors. SEV-SNP protects the integrity of the guest VM by introducing RMP to record and check the ownership of the guest VM's memory pages. Therefore, SEV-SNP is expected to be immune to certain previously known attacks.

Unlike prior SEV attacks, a novel side channel attack on SEV (including SEV-ES and SEV-SNP) processors, called ciphertext side channel, is presented. It allows a privileged hypervisor to monitor the changes of the ciphertext blocks on the guest VM's memory pages and exfiltrate secrets from the guest VM. The root cause of the ciphertext side channel is two-fold: First, the SEV's memory encryption engine uses an XOR-Encrypt-XOR (XEX) mode of operation, which encrypts each 16-byte memory block independently and preserves the one-to-one mapping between the plaintext and ciphertext pairs for each physical address. Second, the design of SEV does not prevent the hypervisor from reading the ciphertext of the encrypted guest VM's memory, thus allowing the hypervisor to monitor ciphertext changes during the execution of the guest VM.

To demonstrate the severity of leakage due to the ciphertext side channel, a CipherLeaks attack is constructed such that it exploits the ciphertext side channel on the encrypted VMSA page of the guest VM. Specifically, the CipherLeaks attack monitors the ciphertext of the VMSA during VMEXITs, then, (1) by comparing the ciphertext blocks with the ones observed during previous VMEXITs, an adversary may learn that the corresponding register values have changed and infer therefrom the execution state of the guest VM; and (2) by looking up a dictionary of plaintext-ciphertext pairs collected during the VM boot up period, the adversary may recover some selected values of the registers. With these two attack primitives, it is shown that a malicious hypervisor may leverage the ciphertext side channel to steal the private keys, e.g., from the constant-time implementation of the RSA and Elliptic Curve Digital Signature Algorithm (ECDSA) algorithms in the latest OpenSSL library, which are believed to be immune to side channels.

Countermeasures of the ciphertext side channel and the specific CipherLeaks attack are discussed. While there are some seemingly feasible software countermeasures, it is shown that these become fragile when a CipherLeaks attack is performed using an APIC. Therefore, the ciphertext side-channel vulnerability may be difficult to eradicate from the software. Accordingly, it is desirable to have appropriate hardware systems and methods for future SEV hardware. Software countermeasures are discussed in Section E.1.

The presented embodiments comprise the following contributions to the security of AMD SEV and confidential computing technology in general:

1) a novel ciphertext side channel on SEV processors that exposes a fundamental flaw in the SEV's use of XEX mode memory encryption;

2) a new CipherLeaks attack that exploits the ciphertext side channel to infer register values from encrypted VMSAs. Two attack primitives are constructed for inferring the execution states of the guest VM and recovering specific values of registers;

3) successful attacks against the constant-time RSA and ECDSA implementation of the latest OpenSSL library, which have been considered secure against side channels;

4) discussion on the applicability of the CipherLeaks attack on SEV-SNP. The CipherLeaks attack appear to be a successful attack against SEV-SNP that breaches the memory encryption of the guest VM; and

5) discussion of potential software and hardware countermeasures for the ciphertext side channel and the demonstrated CipherLeaks attack.

B. General Background Information

1. Secure Encrypted Virtualization

SEV is a new feature in AMD processors. AMD introduces SEV for protecting virtual machines (VMs) from an untrusted hypervisor. Using the memory encryption technology, each VM is encrypted with a unique AES encryption key, which is not accessible from the hypervisor or the VMs. The encryption is transparent to both hypervisor and VMs and occurs inside dedicated hardware in an on-die memory controller. The in-use data in each VM is automatically encrypted with their corresponding key, and thus no additional software modifications are needed to run programs containing sensitive secrets in the SEV platform. Two other critical components for the SEV-enabled VMs are Open Virtual Machine Firmware (OVMF), the UEFI for x86 VM, and Quick Emulator (QEMU), the device simulator.

Encrypted Memory. SEV hardware encrypts the VM's memory using 128-bit AES symmetric encryption. The AES engine integrated into the AMD System-on-Chip (SOC) automatically encrypts the data when it is written to the memory and automatically decrypts the data when it is read from memory. For SEV, AES encryption uses the XOR-and-Encrypt (XE) encryption mode, which has been changed to an XEX mode encryption. Thus, each aligned 16-byte memory block is encrypted independently. SEV utilizes a physical address-based tweak function T( ) to prevent an attacker from directly inferring plaintext, e.g., by comparing 16-byte ciphertext. It adopts a basic XE mode on the first generation of EPYC™ processors (e.g., EPYC™ 7251). The ciphertext c is calculated by XORing the plaintext m with the tweak function T( ) for system physical address Pₘ using c=ENC(m⊕T(Pₘ)), where the encryption key is called VM encryption key (Kᵥₑₖ). This basic XE encryption mode can be easily reverse-engineered by an adversary since the tweak function vectors tᵢs are fixed. AMD replaced the XE mode encryption with the XEX mode in EPYC™ 7401P processors where the ciphertext is calculated by c=ENC(m⊕T(Pₘ))⊕T (Pₘ). The tweak function vectors tᵢs are proved to have only 32-bit entropy at first, which allows an adversary to reverse engineer the tweak function vectors. AMD adopted a 128-bit entropy tweak function vectors in their Zen 2 architecture EPYC™ processors since July 2019 and, thus, fixed those vulnerabilities in SEV AES encryption. However, the same plaintext always has the same ciphertext in system physical address Pm during the lifetime of a guest VM.

SEV, SEV-ES, and SEV-SNP. The first version of SEV was released in April 2016. AMD later released the second generation SEV-ES in February 2017 and a whitepaper regarding the third generation SEV-SNP in January 2020. SEV-ES is designed to protect the register states during the world switch and introduces the VMSA to store the register states encrypted by Kᵥₑₖ. SEV-SNP is designed to protect the integrity of the VM's memory and introduces the RMP to store the ownership of each memory pages. Although SEV, SEV-ES, and SEV-SNP use the same AES encryption engine, additional memory access restrictions are included in SEV-SNP for integrity protection. In SEV and SEV-ES, the hypervisor has read/write access to the VM's memory regions, which means that the hypervisor can directly read or replace the ciphertext of the guest VM. In SEV-SNP, RMP checks prevent a hypervisor from altering ciphertext in the guest VM's memory by adding an ownership check before memory access is granted. However, the hypervisor still has read access to the ciphertext of the guest VM's memory.

Non-Automatic VM Exits. VMEXITs in SEV-ES and SEV-SNP are classified as either Automatic VM Exits (AEs) or Non-Automatic VM Exits (NAEs). AE VMEXITs are events that do not need to expose any register states to the hypervisor. These events include: machine check exception, physical interrupt, physical Non-Maskable-Interrupt, physical Init, virtual interrupt, pause instruction, hlt instruction, shutdown, write trap of CR[0-15], nested page fault, invalid guest state, busy bit, and VMGEXIT. All other VMEXITs are classified as NAE VMEXITs, which require exposing some register values to the hypervisor.

Instead of being trapped directly by the hypervisor, NAE events first result in a VC exception that is handled by a VC handler inside the guest VM. The VC handler then inspects the NAE event's error code and decides which registers should be exposed to the hypervisor. The VC handler copies those registers' states to a special structure called Guest-Hypervisor Communication Block (GHCB), which is a shared memory region between the guest and the hypervisor. After copying those registers' states to the GHCB, the VC handler executes a VMGEXIT instruction to trigger an AE VMEXIT. The hypervisor then traps the VMGEXIT VMEXIT, reads those states from the GHCB, handles the VMEXIT, writes the return registers' states into the GHCB if needed, and executes a VMRUN instruction. After the VMRUN instruction, the guest VM's execution will resume after the VMGEXIT instruction inside the VC handler, which copies the return values from the GHCB to the corresponding registers, and then exits the VC handler. For example, to handle CPUID instructions, the VC handler stores the states of RAX and RCX registers and the VM EXITCODE (0x72 for CPUID) into the GHCB and executes a VMGEXIT. The hypervisor then emulates the CPUID instruction and updates the values of the RAX, RBX, RCX, and RDX registers in the GHCB. After the VMRUN instruction, the VC handler checks if those return registers' states are valid and copies those states to its internal registers.

IOIO_PROT. During the Pre-Extensible Firmware Interface (PEI) initialization phase of SEV VM, IOIO port is used instead of direct memory access (DMA). The reason is that DMA inside SEV VM requires a shared bounce buffer between VM and the hypervisor. The guest VM needs to copy DMA data from the bounce buffer to its private memory for input data, and copy data from its private memory to the bounce buffer for output data. Implementing bounce buffer involves allocating dynamic memory and additional memory copy operations, which is a challenge in the PEI initialization phase.

An IOIO_PROT event is one of the NAE events that exposes register states to the hypervisor. Several pieces of information are returned to the hypervisor in the GHCB. SW_EXITCODE contains an error code (e.g., 0x7b) of IOIO_PROT events. SW_EXITINFO1 contains the intercepted I/O port (bit 31:16), address length (bit 9:7), operand size (bit 6:4), repeated port access (bit 3), and access type (e.g., IN, OUT, INS, OUTS) (bit 2,0). The SW_EXITINFO2 is used to save the next RIP in non-SEV VM and SEV VM, masked to 0 in SEV-ES and SEV-SNP. For IN instructions, the hypervisor puts the RAX value into the RAX field of the GHCB before the VMRUN instruction; for OUT instructions, the VC handler places the RAX register value into the RAX field of the GHCB before the VMGEXIT.

2. Cryptographic Side-Channel Attacks

Timing attack. Timing attacks against cryptographic implementations are a subset of side-channel attacks where an attacker exploits the time difference in the execution of a specific cryptographic function to steal secret information. Any functions that have secret-dependent execution time variation are vulnerable to timing attacks. However, whether secrets can be stolen in practice depends on many other factors, such as the implementation of the cryptographic function, the hardware supporting the program, the accuracy of the timing measurements, etc. In 1996, the first timing attack on an RSA implementation was published. In 2003, a practical timing attack against SSL-enabled network servers was demonstrated where a server's private key was recovered based on the RSA execution time difference. In fact, timing attacks are practical not only against RSA but also against other crypto algorithms, including ElGamal and the Digital Signature Algorithm.

Architecture side channel attack. Micro-architecture side channels use shared CPU architecture resources to infer a victim program's behavior, mostly by exploiting timing differences. Some commonly-used shared resources in micro-architecture side channels include Branch Target Buffer (BTB), Cache (L1, L2, L3 cache), Translation Look-aside Buffer (TLB), the CPU internal load/store buffers, etc. Some representative micro-architecture side-channel techniques include Flush+Reload attacks, Prime+Probe attack, utag attacks, and Flush+Flush attacks. It has been shown that architecture side channels can be exploited and used to break confidentiality in a local or cloud setting.

Constant-time Cryptography. Constant-time cryptography implementations are widely used in mainstream cryptography libraries to mitigate timing attacks. The design of constant-time functions is used to reduce or eliminate data-dependent timing information. Specifically, constant-time implementations make the execution time independent of the secret variables and, therefore, do not leak any secret information to timing analysis. To achieve constant execution time, three rules should be followed. First, the control-flow paths cannot depend on the secret information. Second, the accessed memory addresses cannot depend on the secret information. Third, the inputs to variable-time instructions, such as division and modulus, cannot depend on the secret information. A number of tools assess constant-time implementations, including Imperial Violet, dudect, and ct-verif.

3. Advanced Programmable Interrupt Controller

AMD processors provide an Advanced Programmable Interrupt Controller (APIC) for software to trigger interrupts. Each CPU core is associated with an APIC, and several interrupt resources are supported, including APIC timer, performance monitor counter, and I/O interrupts. In the APIC timer mode, a programmable 32-bit APIC-timer counter, can be used by software to generate APIC interrupts. Periodic and one-time modes are supported. In the one-shot mode, a counter can be set to a software-defined initial value and decrease with clock rate. Once the counter reaches zero, an APIC interrupt is generated on this CPU core. In the period mode, the counter is automatically initialized to the initial value after reaching zero, and an interrupt is generated each time the counter reaches zero.

The APIC is used in SGX-Step to single-step the enclave program on Intel SGX. SGX-Step builds a user space APIC interrupt handler to intercept each APIC timer interrupt. Meanwhile, SGX-Step sets a one-shot APIC timer with a fixed value right before ERESUME. The fixed timer value is configured such that an APIC timer interrupt is generated after a single instruction is executed inside the enclave. These steps are repeated to a single-step every instruction inside the enclave. SGX-Step can achieve a single-step ratio of about 98% under a machine-specific fixed counter value.

C. The CipherLeaks Attack

This section explores the side-channel leakage caused by SEV's XEX mode encryption and demonstrates its consequences when applied to the encrypted VMSA page. Two main attack primitives are constructed: execution state inference and plaintext recovery.

1. The Ciphertext Side Channel

Considering a scenario where the victim VM is a SEV-SNP-protected VM hosted by a malicious hypervisor, and assuming that SEV properly protects the integrity of the encrypted VM memory as well as VMSA pages, existing attacks against SEV and SEV-ES are deemed not applicable. A goal of the CipherLeaks attack is to steal secrets from the victim VM. Denial-of-service attacks and speculative execution attacks are out of scope.

a) Root Cause Analysis

Because SEV's memory encryption engine uses 128-bit XEX-mode AES encryption, each 16-byte aligned memory block in the VMSA is independently encrypted with the same AES key. Since each 16-byte plaintext is first XORed with a physical-address-specific 16-byte value (i.e., the output of the tweak function) before encryption, the same plaintext may yield different ciphertext when placed in a different physical address. However, the same 16-byte plaintext is always encrypted into the same ciphertext when placed in the same physical address. Most importantly, existing SEV approaches, including SEV-ES and SEV-SNP, do not prevent a hypervisor from accessing and reading the ciphertext of the encrypted memory (which is different from SGX).

This observation forms the foundation of the ciphertext side channel: By monitoring the changes in the ciphertext of the victim VM, the adversary may infer the changes of the corresponding plaintext. This ciphertext side channel may seem innocuous at first glance, but when applied to certain encrypted memory regions, it may be exploited to infer the execution of the victim VM.

b) CipherLeaks: VMSA Inferences

The CipherLeaks attack is a category of attacks that exploit the ciphertext side channel by making inferences on the ciphertext of the VMSA.

VMSA structure. Before SEV-ES, register states were directly saved into the VMCB during the VMEXITs without hiding the states from the hypervisor, which gives the hypervisor a chance to inspect the internal states of the VM's execution or change the control flow of software inside the VM. AMD fixes this unencrypted-register-state vulnerability by encrypting the registers during VMEXITs. In SEV-ES and SEV-SNP, the register states are encrypted and then saved into VMSA during VMEXITs. Thus, SEV-ES and SEV-SNP add confidentiality and integrity protection to the saved register values in the VMSA.

Confidentiality. The VMSA is a 4 KB page-aligned memory region specified by the VMSA pointer in VMCB's offset 108h. All register states saved in the VMSA are also encrypted with the VM encryption key Kᵥₑₖ.

Integrity. To prevent the hypervisor from tampering with the VMSA, SEV-ES calculates the hash of the VMSA region before VMEXITs and stores the measurement into a protected memory region. Upon VMRUN, the hardware checks the integrity of the VMSA to prevent any modification of the VMSA data. Instead of performing such integrity checks, SEV-SNP prevents the hypervisor from writing to the guest VM's memory (including VMSA pages) via RMP permission checks.

Overview of CipherLeaks. The CipherLeaks attack exploits the ciphertext side channel on the encrypted VMSA during VMEXITs. During an AE VMEXIT, all guest register values are stored in the VMSA, which is an encrypted memory page. The encryption of the VMSA page also follows the same rule as other encrypted memory pages. Moreover, as the physical address of the VMSA page is chosen by the hypervisor and remains the same during the guest VM's life cycle, the hypervisor can monitor specific offsets of the VMSA to infer changes of any 16-byte plaintext. Some saved registers and their offset in the VMSA are listed in Table 1.

TABLE 1
Ciphertext of registers collected in the VMSA. If
the content at a specific offset is 8 bytes, it
means that the remaining 8 bytes are reserved.

| Offset | Size | | Content |
|---|---|---|---|
| 150h | 16 | bytes | CR3 & CR0 |
| 170h | 16 | bytes | RFLAGS & RIP |
| 1D8h | 8 | bytes | RSP |
| 1F8h | 8 | bytes | RAX |
| 240h | 8 | bytes | CR2 |
| 308h | 8 | bytes | RCX |
| 310h | 16 | bytes | RDX & RBX |
| 320h | 8 | bytes | RBP |
| 330h | 16 | bytes | RSI & RDI |
| 340h | 16 | bytes | R8 & R9 |
| 350h | 16 | bytes | R10 & R11 |
| 360h | 16 | bytes | R12 & R13 |
| 370h | 16 | bytes | R14 & R15 |

Some 16-byte memory blocks store two 8-byte register values. For instance, CR3 and CRO are stored at offset 0x150. If either of the two registers changes its value, the corresponding ciphertext will change. Because the CRO register does not change very frequently, in most cases, the ciphertext of this block differs because the value of register CR3 changes, from which one may infer that a context switch has taken place inside the victim VM. Thus, the ciphertext pair (CR0, CR3) may be used to identify processes inside the victim VM. For other cases, such as for the (RBX, RDX) and (R10, R11) pairs, as both registers are subject to frequent changes, it is only possible to learn that the value of one (or both) of the two registers has changed. The adversary may learn which register has changed if the adversary knows the executed binary code between the two VMEXITs. Some 16-byte memory blocks only store values for a single 8-byte register (e.g., RAX and RCX), and the remaining 8 bytes are reserved. Reserved fields are all zeroes, so they do not change. Therefore, by using information such as that in Table 1, one may construct one-to-one mappings from ciphertext to plaintext for the values of registers RAX, RCX, RSP, RBP, and CR2.

2. Execution State Inference

Two attack primitives of CipherLeaks are described in Section C.2.a) and Section C.3.a). Shown first is the use of the ciphertext side channel to infer the execution states of processes inside the guest VM, which helps locate the physical address of targeted functions and infer the executing function of a process.

a) Attack Primitives

To infer the execution states of the encrypted VM, one may the following steps:

1) At time t₀, the hypervisor may clear the present bits (P-bits) of all memory pages in the victim VM's NPT. The next memory access from the victim VM may trigger a VMEXIT caused by a nested page fault (NPF).

2) During VMEXITs, the hypervisor may read and record the ciphertext blocks in the victim VM's VMSA, as well as the timestamps and VMEXIT's EXITCODE. Before VMRUN, the hypervisor may reset the P-bit of the faulting page such that the victim VM may continue execution. However, the attacker may choose to clear the P-bit again later, e.g., to trigger more VMEXITs. This step is similar to controlled channel attacks.

3) The hypervisor may collect a sequence of ciphertext blocks and timestamps. By comparing the ciphertext of the CR3 and CR0 fields, the hypervisor may associate each observation to a particular process in the victim VM. Therefore, changes in the ciphertext blocks belonging to the same process can be collected to infer its execution states.

The NPF's error code passed to the hypervisor via VMCB's EXITINFO2 field reveals valuable information for the side-channel analysis. For example, as shown in FIG. 1B, error code 0x100000014 always means the NPF is caused by an instruction fetch. The NPF error code is specified in Table 2.

TABLE 2
Information revealed from NPF error code

| Bit | Description |
|---|---|
| Bit 0 (P) | Cleared to 0 if the nested page was non-present |
| Bit 1 (RW) | Set to 1 if it was a write access |
| Bit 2 (US) | Set to 1 if it was a user access |
| Bit 3 (RSV) | Set to 1 if reserved bits were set |
| Bit 4 (ID) | Set to 1 if it was a code fetch |
| Bit 6 (SS) | Set to 1 if it was a shadow stack access |
| Bit 32 | Set to 1 if it was a final physical address |
| Bit 33 | Set to 1 if it was a page table |
| Bit 37 | Set to 1 if it was a supervisor shadow stack page |

The ciphertext itself is meaningless, but the fact that it changes matters. A vector whose size is the same as the number of registers that are monitored is used to represent value changes in the ciphertext. A value +1 in the vector indicates that the corresponding register has changed since the last NPF. Therefore, a sequence of such vectors may be collected.

With the information described above, the hypervisor may profile the applications through a training process.

b) Examples

One example of such attack primitives is locating the physical address of targeted functions in the victim. Such attacks are illustrated in the example in FIG. 1A and FIG. 1B, where FIG. 1A depicts source code with assembly code, and FIG. 1B depicts ciphertext blocks. Focusing on two callq instructions (labeled “2” and “3” in FIG. 1A) in the caller function, it is assumed that the hypervisor has some pre-knowledge of the application code running in the guest VM and that the hypervisor begins to monitor the application by clearing the P-bits before the two call instructions (e.g., before label “1” in FIG. 1A). In handling each NPF, the hypervisor collects the ciphertext of those saved registers listed in Table 1 as well as the NPF's error code.

The hypervisor then collects a sequence of ciphertext blocks as shown in FIG. 1B. The callq instruction (labeled “2” in FIG. 1A) touches a new instruction page that contains the code of sum( ). Therefore, it triggers an NPF. Compared to the previous snapshot, the changes of the ciphertext of RIP, RSP, RBP, and RDI are observed; the ciphertext in CR3 and RAX remains unchanged. When sum( ) returns, the return value is stored in the RAX register. The ciphertext changes of the RAX register will be observed in the next NPF (labeled “3” in FIG. 1A), where RIP will also change. In this way, the hypervisor can locate the physical address of the functions and trace the control flow of the target application. In particular, NPF1 reveals the physical address of the function sum( ), and NPF2 reveals the physical address of the function expand( ).

3. Plaintext Recovery

The ciphertext side channel can also be exploited to recover the plaintext from some of the ciphertext blocks. To recover plaintext from ciphertext, the adversary first builds a dictionary of plaintext-ciphertext pairs for the targeted registers, and then make use of the dictionary to recover the plaintext value of the registers of interest during the execution of a sensitive application.

a) Attack Primitive

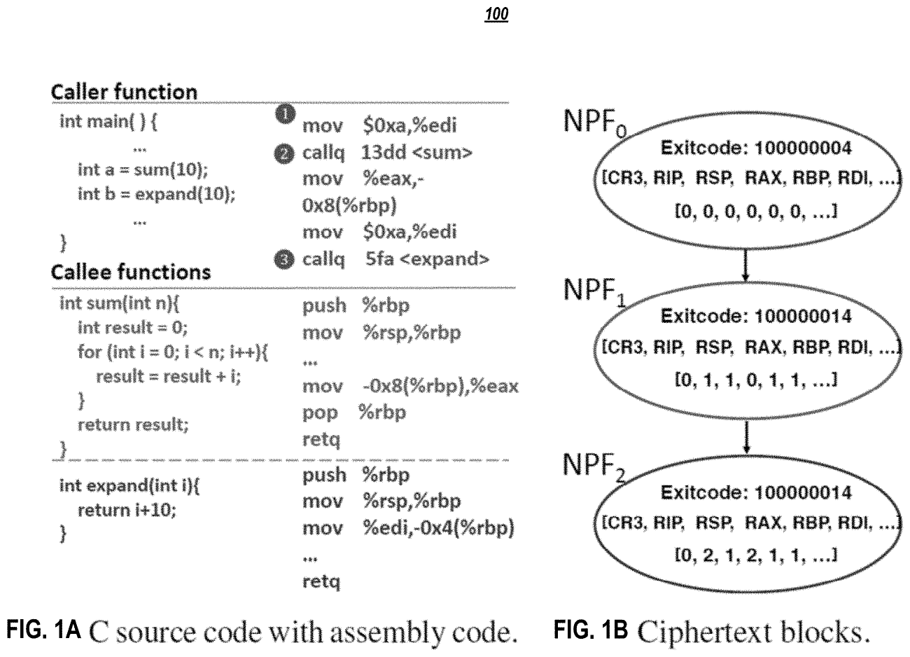

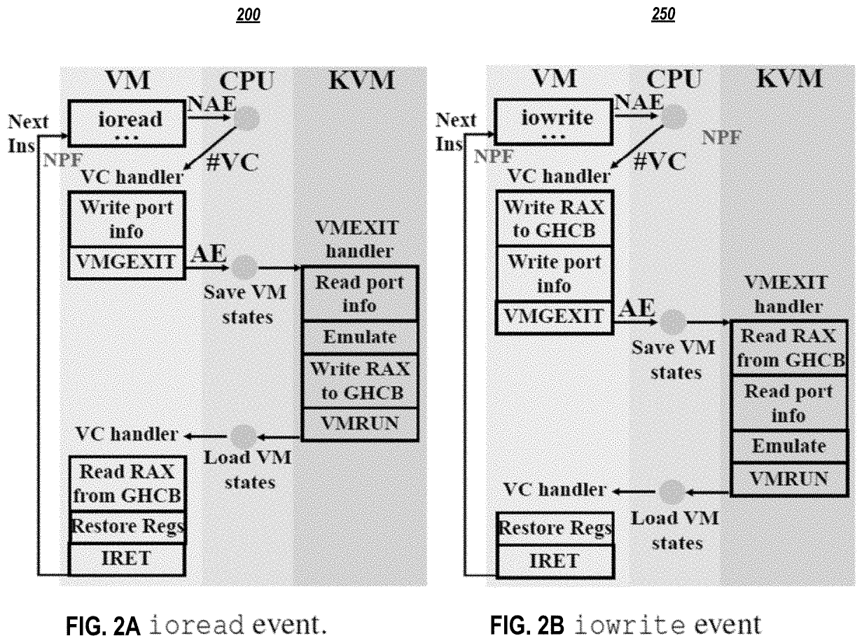

During some NAE events, the guest kernel may exchange register states with the hypervisor through GHCB. Thus, the plaintext value of specific registers may be learned when these register states are stored in the GHCB. The hypervisor can thus collect plaintext-ciphertext pairs for those registers. Because different registers have different offset in the VMSA and different physical addresses, we need to build the dictionary of plaintext-ciphertext pairs for each register separately. There are two ways to collect such pairs, depending on what stores the register values to GHCB. First, for those NAE events where the hypervisor returns emulated registers to the guest VM, the hypervisor may clear the P-bit of the instruction page that triggers the NAE events before VMRUN. Thus, after the VC handler uses IRET to return to the original instruction page, an NPF will occur, and the hypervisor may obtain the ciphertext of corresponding registers while handling this NPF. FIG. 2A shows an example for collecting plaintext-ciphertext pairs of RAX from IOIO_PROT events (ioread). The hypervisor records the plaintext of RAX when emulating the VMEXIT and obtains the ciphertext of RAX when handling the NPF caused by IRET.

Second, for those NAE events where the VM exposes registers to the hypervisor, the hypervisor may periodically clear the P-bit of the VC handler code and record the ciphertext of all registers in VMSA whenever there is an NPF triggered by the VC handler code. At the next NAE event, the plaintext of some registers will be written to the GHCB, and their corresponding ciphertext can be found from the last VC handler triggered NPF. FIG. 2B shows an example for collecting plaintext-ciphertext pairs of RAX from IOIO_PROT events (iowrite). The hypervisor obtains the ciphertext of RAX either when handling the VC-exception-triggered NPF after the NAE event or when handling the NPF caused by IRET and learns the plaintext of RAX when handling the VMEXIT.

b) Examples

The adversary may use the NAE VMEXITs to collect a dictionary of plaintext-ciphertext pairs for certain registers stored in VMSA. One possible method leverages IOIO_PROT (error code=0x7b) NAE VMEXIT events to collect the ciphertext of the RAX register when its plaintext values are between 0 and 127.

Building the dictionary of plaintext-ciphertext pairs. During the PEI phase, the guest VM accesses the memory region that stores the information about the Nonvolatile BIOS settings (CMOS) and the Real-Time Clock (RTC) through IO ports 0x70 and 0x71. The OVMF code ensures the correctness of the CMOS/RTC by calling a function named DebugDumpCmos when loading the PlatformPei PEI Module (PEIM) during the initialization of the guest VM. DebugDumpCmos checks the CMOS/RTC by writing the offset of CMOS/RTC to port 0x70 and then reading one byte of data from port 0x71. DebugDumpCmos enumerates offset 0x00-0x7f (i.e., 0-127) during the PEI phase to access the CMOS/RTC information.

In both SEV-ES and SEV-SNP, every iowrite and ioread in IOIO_PROT are first trapped and handled by the VC handler. The VC handler and the hypervisor then cooperate to emulate iowrite and ioread as shown in respective FIG. 2A and FIG. 2B. For iowrite, the VC handler copies the RAX value to GHCB before calling VMGEXIT. For ioread, the VC handler copies the RAX state from GHCB to RAX register after VMGEXIT. In the iowrite cases, the RAX state after the VC handler finishing handling an iowrite exception and before returning to the sequential instruction should be the same as the RAX state passed to the hypervisor in the VMGEXIT.

In the case of DebugDumpCmos in PlatformPei PEIM, the hypervisor may observe 128 IOIO_PROT events with SW_EXITINFO1 being 0x700210 (indicating that the guest VM is accessing CMOS/RTC information) and increasing RAX values from 0x00 to 0x7f. The hypervisor may also trap the sequential instruction by clearing the P-bit of the physical address of the PlatformPei PEIM's EntryPoint, which will be accessed after the guest VM exiting the VC handler. The guest physical address of EntryPoint may remain, e.g., 0x83a000. It is noted that the hypervisor may also readily locate the physical address of the PlatformPei PEIM because the plaintext of the OVMF file is known to both the guest VM owner and the hypervisor for in-place encryption during the remote attestation.

Each IOIO_PROT event in DebugDumpCmos helps the hypervisor record the ciphertext of a known RAX plaintext value in VMSA when handling the NPF caused by returns to the PlatformPei PEIM. After the DebugDumpCmos, the hypervisor may build a dictionary with 128 plaintext-ciphertext pairs, where the plaintext extends from 0x00 to 0x7F. Some other IOIO_PROT events with the same SW_EXITINFO1 may also occur during the execution of DebugDumpCmos. The hypervisor may distinguish those events by looking at the ciphertext of RFLAG/RIP field in VMSA since all target iowrites inside DebugDumpCmos have the same RFLAG/RIP value.

c) Other Plaintext-Ciphertext Pairs

This section illustrates other plaintext-ciphertext pairs an adversary may collect, e.g., during a boot period of an SEV-enabled VM. Further, plaintext recovery under different OVMF versions and different build configurations are analyzed. Data in this section were collected on a workstation having an 8-Core AMD EPYC™ 7251 processor. The OVMF version used to boot the SEV-ES-enabled VMs may vary according to different settings illustrated in greater detail below. The victim VMs were configured as SEV-ES-enabled VMs with one virtual CPU, 4 GB DRAM, and 30 GB disk storage. The host and guest OS kernel were forked from branch sev-es-v3, and the QEMU version was QEMU sev-es-v12. All code is directly downloaded from AMDs Github repository (commit:96f2b75aaa9801646b410568d12b928cc9f06e0c, Nov. 25, 2020). It is noted that although attacks were performed on SEV-ES machines, SEV-SNP machines are equally vulnerable (see Section F).

Plaintext Range. To show the potential plaintext range the hypervisor may collect, NAE events that have register state interactions with the hypervisor during the boot period of a SEV-ES-enabled VM were monitored. The OVMF version used was downloaded from branch sev-es-v27 with the default setting.

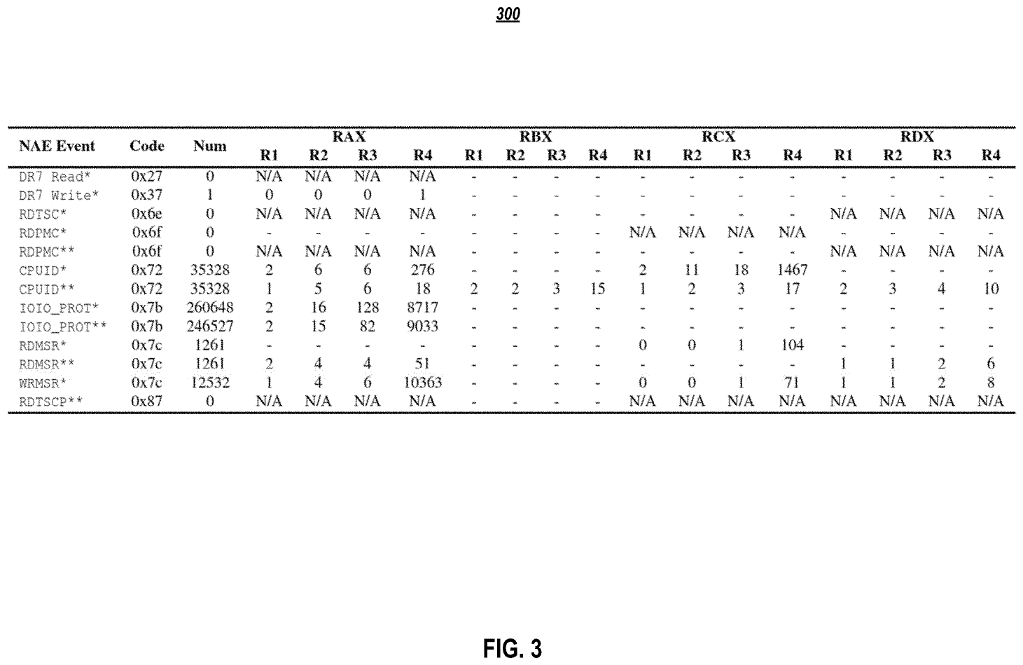

FIG. 3 depicts various NAE events observed during a boot period and exemplary register state ranges that may be exposed, according to embodiments of the present disclosure. In FIG. 3, “Num” represents the number of NAE event being observed. “*” represents state to hypervisor. “**” represents state from hypervisor, “NIA” represents not observed. “-” represents a register that is not supposed to be used during this NAE event. As shown, the collected register states are divided into four intervals, Range 1 (R1) through Range 4 (R4).

R1 represents numbers of different exposed register states lying in fields [0, 1], Range R2 (R2) represents numbers of different exposed register states lying in range [0, 15], and so on. Since R1 comprises fields [0, 1], only two numbers and represents an important interval since a return of true or false is very common in function implementation. Most observed NAE events may help the hypervisor to collect both two values in R1 while frequent IOIO_PROT (260648 for IO out and 246527 for IO in) events during the boot period can help the hypervisor to fill R2 and R3. R4 comprises all 2⁶⁴ for an 8-byte register. Some NAE events are not observed during the boot period like RDPMC and RDTSC. However, these NAE events may still be considered exploitable as long as some programs use these instructions during the VM's lifetime. Registers RBX and RDX in FIG. 3 are separated to present different register values that the hypervisor may observe during the boot period. However, an adversary may only observe the ciphertext of the (RBX, RDX) pair since these two registers are in a same aligned 16-byte encryption block.

Different Versions. Tested were, as of Nov. 25, 2020, three OVMF git branches provided by AMD for SEV-ES (“sev-es-v27”) and SEV-SNP (“sev-es-v21+snp”) as well as the official OVMF repository used by SEV (“https://github.com/tianocore/edk2.git”). These three versions adopt the same CMOS/RTC design flow mentioned in this section under the default configuration provided by AMD, and the hypervisor is able to collect all the 7-bits (plaintext from 0 to 0x7F) plaintext-ciphertext pairs in the three versions.

Different Settings. Also tested were OVMF debug configuration options. The default debug configuration is to write debug messages to IO port 0x402. OVMF further supports original debug behavior where the debug messages are written to the emulated serial port if the DEBUG_ON_SERIAL_PORT option is set. AMD adopts the DEBUG_ON_SERIAL_PORT option according to their Github repository. In both settings, the hypervisor may collect all the 7-bit plaintext-ciphertext pairs, e.g., by monitoring CMOS/RTC activities in I/O PORT 0x70. The DebugDumpCmos may be disabled if a developer chooses to ignore all debug information by setting the -b RELEASE option. However, the hypervisor may still collect 19 of the 7-bit plaintext-ciphertext pairs (with 2 numbers lying in R1, 13 numbers in R2, and 19 numbers in R3) by monitoring CMOS/RTC activities in I/O PORT 0x70. By targeting different events, the hypervisor may collect some data. If the hypervisor monitors only IOIO_PROT OUT events, the hypervisor can collect 115 of the 7-bit plaintext-ciphertext pairs (with 2 numbers lying in R1, 16 numbers in R2, and 115 numbers in R3), even when all debug activities are disabled.

D. Case Studies

This section presents two case studies that illustrate CipherLeaks attacks. In the first attack, it is shown that the constant-time RSA implementation in OpenSSL may be broken with known ciphertext for the plaintext values of 0 to 31. The second attack shows that the constant-time ECDSA signature may be compromised with known ciphertext of the plaintext values of 0 and 1.

1. Breaking Constant-Time RSA

RSA employs asymmetric cryptography, which is widely used in crypto systems. In the RSA algorithm, the plaintext message m may be recovered from the ciphertext c via m=c^{d} mod n, where d is the private key and n is the modulus of the RSA public key system. As such, it can be shown how the CipherLeaks attack may be used to steal the private key d.

Targeted RSA implementation. The demonstrated attack targets at the modular exponentiation used in RSA operations from the OpenSSL implementation as of Nov. 4, 2020. OpenSSL implements the modular exponentiation using a fixed-length sliding window method in function BN_mod_exp_mont_consttime( ). Targeted is a while loop inside this function, which iteratively calculates the exponentiation in 5-bit windows. The while loop is shown in Listing 1, which depicts a code segment of the function BN_mod_exp_mont_consttime. For a 2048-bit private key, the while loop has about 2048/5=410 iterations. In each iteration, bn_get_bits5 is called to retrieve a 5-bit portion of the private key d.

Listing 1: Code snippet of BN_mod_exp_mont_consttime.

1: /*

2: * Scan the exponent one window at a time starting from the most significant bits.

3: */

4: while (bits >0) {

5: bn_power5 (tmp.d, tmp.d, powerbuf, np, n0, top, bn_get_bits5 (p->d, bits-=5));

6: }

The attacker may steal the 2048-bit private key d using the following steps:

(1) Infer the physical address of the target function. The attacker may first use the method introduced in Section C.2 to obtain the physical address of the target function. _{g}PAₜ₀ and _{g}PAₜ₁ to denote the guest physical addresses of the target functions bn_power5 and bn_get_bits5, respectively.

(2) Monitor NPFs. The attacker may clear the P-bit of the two targeted physical pages. Once an NPF of _{g}PAₜ₀ is intercepted, the attacker may clear the P-bit of _{g}PAₜ₁; when an NPF of _{g}PAₜ₁ is intercepted, the attacker may clear the P-bit of _{g}PAₜ₀. For a 2048-bit RSA encryption, 410 iterations can be observed, and the attacker will observe a total of 820 NPFs of _{g}PAₜ₀ and _{g}PAₜ₁.

(3) Extract the private key d. As shown in Listing 2, which depicts a code segment of the function bn_get_bits5, bn_get_bits5 obtains 5 bits of d in each iteration, stores the value in register RAX, and returns. Since the hypervisor clears the P-bit of _{g}PAₜ₀, returns to bn_power5 will trigger an NPF of _{g}PAₜ₀. When the hypervisor handles this NPF, it reads and records the ciphertext of register RAX in the VMSA. The RAX register now stores 5 bits of the private key d and has a value range of 0 to 31. The hypervisor may infer the plaintext by searching the plaintext-ciphertext pairs collected during the boot period as described in Section C.3.b). As a result, the hypervisor can recover the entire 2048-bit private key d after a total of 410 iterations.

Listing 2: Code segment of bn_get_bits5( ).

1: .globl bn_get_bits5
2: . . .
3: cmova % r11, % r10
4: cmova % eax, % ecx
5: movzw (% r10, $num, 2), % eax
6: shrl % cl, % eax
7: and\$31,% eax
8: ret
9: . . .

2. Breaking Constant-Time ECDSA

ECDSA is a cryptographical digital signature based on elliptic-curve cryptography (ECC). ECDSA generates a signature using the following steps:

1. Randomly generate a 256-bit nonce k.

2. Calculate r=(k×G)ₓ mod n

3. Calculate s=k⁻¹(h(m)+rdₐ) mod n

where G is a base point of prime order on a curve, n is the multiplicative order of the point G, dₐ is the private key, h(m) is the hash of the message m, and (r, s) form the signature. With a known nonce k, the private key dₐ can be directly calculated:

dₐ=r⁻¹×((ks)−h(m)) mod n

As such, a side-channel attack against ECDSA aims to steal the nonce k. The secret private key can be inferred thereafter.

Targeted ECDSA implementation. The demonstrated attack targets the secp256k1 curve, which is used, e.g., in Bitcoin wallets. In the OpenSSL's implementation of Nov. 4, 2020, when ECDSA_do_sign is called to generate a signature, ecdsa_sign_setup is first called to generate a random 256-bit nonce k per NIST SP 800-90A standard. To do so, EC_POINT_mul, ec_wNAF_mul, and then ec_scalar_mul_ladder are called to compute r, which is the x-coordinate of nonce k. ec_scalar_mul_ladder is used regardless of the value of the BN_FLG_CONSTTIME flag.

As shown in Listing 3, which depicts a code segment of ec_scalar_mul_ladder( ), the core component of ec_scalar_mul_ladder uses conditional swaps (a.k.a., EC_POINT_CSWAP) to compute point multiplication without branches. Specifically, in each iteration, BN_is_bit_set(k, i) is called to get the i^{th} bit of the nonce k. The conditional swaps are determined by kbit, which is the XOR result of the i^{th} bit of the nonce k and pbit.

Listing 3: Code segment of ec_scalar_mul_ladder( ).

1: for (i = cardinality_bits - 1; i >= 0; i - -) {
2: kbit = BN_is_bit_set (k, i) \hat{ } pbit;
3: EC_POINT_CSWAP (kbit, r, s, group_top, Z_is_one);
4: //Perform a single step of the Montgomery ladder
5: if (! ec_point_ladder_step (group, r, s, p, ctx))
6: {
7: ERR raise (ERR_LIB_EC, EC_R_LADDER_STEP_FAILURE);
8: goto err;
9: }
10: //pbit logic merges this cswap with that of the next iteration
11: pbit = kbit;

The attacker may steal the nonce k using the steps comprising:

(1) Infer the functions' physical addresses. The attacker may first obtain the guest physical addresses of the target functions ec_scalar_mul_ladder _{g}PAₜ₀ and BN_is_bit_set _{g}PAₜ₁ using the above-mentioned execution inference method.

(2) Monitor NPFs. The attacker may clear the P-bit of the two targeted physical pages. Once an NPF of _{g}PAₜ₀ is intercepted, the attacker may clear the P-bit of _{g}PAₜ₁; when an NPF of _{g}PAₜ₁ is intercepted, the attacker may clear the P-bit of _{g}PAₜ₀. In this way, the control flow internal to the ec_scalar_mul_ladder function can be learned by the attacker.

(3) Learn the value of k. In the 256-iteration while loop, the attacker will observe 256*5=1280 NPFs of _{g}PAₜ₀ and 1280 NPFs of _{g}PAₜ₁. In each iteration of the while loop, the first NPFs of _{g}PAₜ₀ is triggered of BN_is_bit_set( ), when BN_is_bit_set returns. Listing 4 depicts an assembly code segment of BN_is_bit_set( ). As shown, the i^{th} bit of the nonce k is returned in register RAX. Thus, the i^{th} bit of the nonce k is stored in the RAX field of the VMSA for the first NPFs of _{g}PAₜ₀ in each iteration. The attacker may then compare the ciphertext of the RAX field to recover the nonce k.

Listing 4: Assembly code snippet of BN_is_bit_set( )

1: 000 f8e20 < BN_is_bit_set >:

| 2: | | ...... | |
|---|---|---|---|
| 3: f8e38: | 48 8b 04 d0 | mov | (% rax, % rdx, 8), % rax |
| 4: f8e3c: | 48 d3 e8 | shr | %cl, % rax |
| 5: f8e3f: | 83 e0 01 | and | $0x1, % eax |
| 6: f8e42: | f3 c3 | repz | retq |

| | |
|---|---|
| 7: | ...... |

3. Evaluation

End-to-end attacks in this section were evaluated on a workstation having an 8-Core AMD EPYC™ 7251 processor. The victim VM was configured as SEV-ES-enabled VMs having a virtual CPU, 4 GB DRAM, and 30 GB disk storage. The versions of the guest and host OS, QEMU, and OVMF are the same as described in Section C.3.c) The OpenSSL from Github was used in the evaluation (commit:8016faf156287d9ef69cb7b6a0012ae0af631ce6, Nov. 4, 2020). These attacks may also be applied to VMs with multiple vCPUs, e.g., if the adversary collects ciphertext-plaintext dictionaries for each vCPU independently as each vCPU has its own VMSA.

To locate the physical address of the target function, the attacker may train the pattern of ciphertext changes in a training VM (a different VM from the victim VM). In the training VM, the attacker first repeats the RSA encryption and the ECDSA signing several times by calling APIs from the OpenSSL library (with the same version as the targeted OpenSSL library in the victim VM). The attacker may collect the NPF sequence, the corresponding VMSA ciphertext changes (see Section C.2), and ground truth information (e.g., guest physical address) for the target functions. In experiments, the pattern of ciphertext changes is relatively stable, especially for a function call that does not have many branches (e.g., ECDSA_do_sign( ) for ECDSA). As such, simple string comparison without sophisticated machine learning techniques may be sufficient for pattern matching.

In the attack phase, the victim VM may perform an RSA encryption or generate an ECDSA signature using the OpenSSL library, which may be remotely triggered by the attacker but is not a necessary condition for a successful attack. As the attacker may not know the start time of the targeted program, the attacker should consider every newly observed CR3 ciphertext as the beginning of the targeted crypto code. It clears all P-bits and starts monitoring the pattern of ciphertext changes. If the expected ciphertext change pattern is observed, the attacker can continue to steal the secret from the victim VM.

In both scenarios, the experiment was repeated ten times, and each time, the attack was able to identify the trained ciphertext pattern and recover the private key d and the secret nonce k with 100% accuracy. The time needed to steal the 2048-bit private key d and the secret nonce k was measured ten times after the ciphertext change pattern is identified. The average time needed to obtain the private key d was 0.40490 seconds with a standard deviation of 0.08920 seconds. The average time needed to steal the secret nonce k was 0.10226 seconds with a standard deviation of 0.00330 seconds.

E. Countermeasures

This section first discusses several potential software-level countermeasures against the CipherLeaks attack, and then discusses that the CipherLeaks attack may still work, e.g., by exploiting the APIC to collect a function's internal state. Hardware-level countermeasures are discussed in Section E.3.

1. Software Mitigation

Solutions to the ciphertext side channel may be categorized according to two purposes: preventing the collection of the plaintext-ciphertext dictionary and preventing exploitation by modifying targeted functions.

Preventing dictionary collection. One potential solution involves removing unnecessary IOIO_PROT events. However, other NAE events may still serve the same purpose as IOIO_PROT. More importantly, as shown in Section D.1, the hypervisor may steal the nonce k with only two plaintext-ciphertext pairs. To render the solution effective, a complete removal of such leakage sources may be required, which is nearly impossible to achieve in current SEV designs.

Preventing exploitation. To fix the target functions, changes to the whole software stack may be necessary. Three potential solutions are listed below. Yet, these approaches may be bypassed, e.g., by using the method outlined in Section E.2.

(1) Masking the return value in RAX. If the return value can be represented in only a few bits, compilers may introduce randomness into the higher bits of the return value. For example, if a returned value is 1, a random number may be added to mask the RAX register, e.g., by returning RAX=0x183af6b800000001, where the higher 4-bytes are randomly generated. The, the caller of the function may ignore the higher bits. In this way, the ciphertext of RAX will be new and thus unknown to the adversary.

(2) Passing return values through memory or other registers. The return value may be passed to the caller via the stack. Since the physical address of the stack frame is hard to predict and collect beforehand, attacks may be prevented. Similarly, the software may also write the return value into other registers (e.g., R10) to avoid using the RAX register.

(3) Using inline functions or keep the callee code on the same page. If the code of the caller and callee are on the same page, for instance, by using inline functions, no NPFs will be triggered during function return.

These three potential solutions require significant rewriting of sensitive functions, which may require compiler-assisted tools to perform. However, the success of such solutions relies on the assumption that the hypervisor cannot infer the internal states of a function call, which, as will be shown in Section E.2, is incorrect.

2. Function's Internal States Intercept

The following APIC-based method allows a hypervisor to single-step functions to intercept the function's internal states. Therefore, the adversary can learn the internal states of a targeted function. Unlike SGX-Step, the APIC handling code may be integrated into the VMEXIT handler of a kernel-based VM (KVM). Moreover, unlike SGX-Step that uses a static APIC interval to interrupt the controller, APIC intervals may be selected since the execution time of VMRUN is not constant. More specifically, the following steps may be performed to interrupt VMRUN:

(1) Infer the functions' physical addresses. The attacker may first obtain the guest's physical addresses of the target function, namely _{g}PAₜ, using the above-mentioned execution inference method.

(2) Dynamically determine APIC timer intervals. The attacker may follow a “0 steps is better than several steps” principle to single-step or intercept a small advancement of the execution of the target function. Because the time used for the VMRUN instruction is not fixed, the hypervisor may start with a small APIC interval to single-step into the guest VM as much as possible. The hypervisor may then examine the VMSA field to determine whether the ciphertext in VMSA has changed; if so, this means that one or more registers' values have changed and the guest VM executes one or more instructions before being interrupted by APIC. One exemplary method to choose a proper APIC time interval is specified in Method 1.

METHOD 1—Dynamic Timer Interval Prediction

```
int apic_time_interval; //APIC interrupts the VM after the interval
int roll_back; //roll back to a small interval after any movement
apic_time_interval = 20;
roll_back = 10; // initialize the setting, may vary in different CPU
while true do
  apic_timer_oneshot(apic_time_interval);
  _svm_sev_es_vcpu_run(svm->vmcb_pa);
  svm_handle_exit(vcpu, physical interrupt VMEXIT);
  if not observe VMSA changes then
    apic_time_interval ++;
  else
    apic_time_interval = apic_time_interval - roll_back;
  end
end
```

(3) Collect the target function's internal states. The hypervisor may collect the internal states of the target function after a WBINVD instruction, which may be used to flush VMSA's cache back to the memory. With a known binary, the hypervisor may also determine the number of the instructions that have been executed, e.g., by comparing the ciphertext blocks changes with the assembly code.

Evaluation. To evaluate the effectiveness of single-stepping the guest VM's execution, experiments are performed on a workstation having an 8-Core AMD EPYC™ 7251 Processor. The victim VM was configured as SEV-ES-enabled VMs having two virtual CPUs, 4 GB DRAM, and 30 GB disk storage. The versions of the guest and host OS, QEMU, and OVMF are the same as described in Section C.3.c). Unlike the previous settings, SEV-ES's debug option was enabled in the guest policy, which allows the hypervisor to use the SEv_CMD_DBG_DECRYPT command to decrypt the guest VM's VMSA. This configuration is used only to collect ground truth data of the experiments, which does not influence the guest VM's execution and is not a required step in practical attacks.

To make the experiments representative, a starting point is randomly selected during the VM's execution to initiate the tests. In each test, Method 1 is used to collect 100 trials. Each trial is collected only when the hypervisor observes changes in the register's ciphertext in the VMSA. Meanwhile, ground truth data is collected by using the SEv_CMD_DBG_DECRYPT command from the hypervisor to decrypt the RIP filed in VMSA. “Δ” is used to represent the number of bytes that the RIP has advanced between two consecutive VMEXITs. It is noted that the SEv_CMD_DBG_DECRYPT command does not affect the execution of the guest VM. The test is repeated 60 times. In total, 6000 trials are collected.

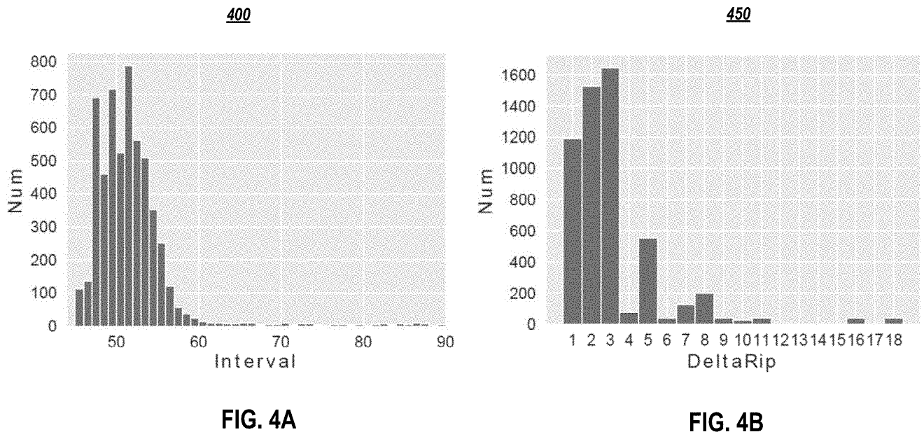

Among 6000 trials, 454 lead to a Δ greater than 20 because of a jmp instruction and, thus, can be filtered out. For the remaining 5546 trials, the APIC-timer intervals that were used to trigger APIC interrupts range from 40 to 90 (with a divide value of 2, which translates to 80 to 180 CPU cycles). The distribution of APIC interrupts is depicted in FIG. 4A. The results suggest that the runtime of the VMRUN instruction is not constant (on SEV-ES VM), which may be caused by the presence of VMCB cache states and the non-constant time VMSA integrity checks. Even though VMRUN is not constant-time, as shown in FIG. 4B, 78.7% of the trials lead to a Δ that is less than three bytes. 90.1% of the trials lead to a Δ that is less than 5 bytes. It is noted that a typical x86 instruction has two to four bytes. These results illustrate that the APIC-based method may successfully interrupt the execution of the guest VM with relatively small steps.

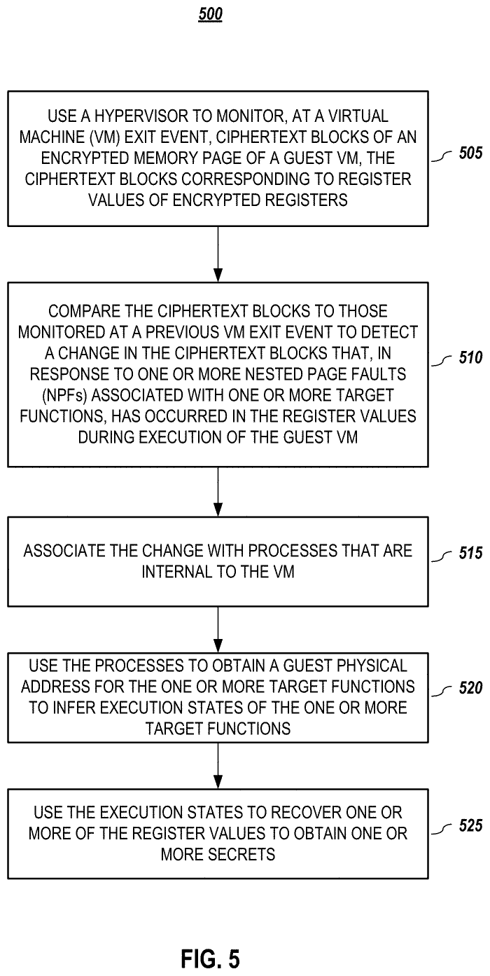

FIG. 5 is a flowchart that illustrates a method for exploiting vulnerabilities in SEV, e.g., by breaching the memory encryption of a guest VM, according to embodiments of the present disclosure. In one or more embodiments, the method for exploiting vulnerabilities in SEV may begin when, a hypervisor is used to monitor (505), e.g., at a VM exit event, ciphertext blocks of an encrypted memory page of a guest VM. The ciphertext blocks may correspond to register values of encrypted registers. The ciphertext blocks may be compared (510) to those monitored at a previous VM exit event such as to detect a change in the ciphertext blocks. The change may have occurred in the register values during execution of the guest VM, e.g., in response to one or more nested page faults (NPFs) associated with one or more target functions. This change may be associated (515) with processes that are internal to the VM, and the processes may be used to obtain (520) a guest physical address for the one or more target functions to infer execution states of the one or more target functions. Finally, the execution states may be used (525) to recover one or more of the register values to obtain one or more secrets.

In one or more embodiments, a stop condition may include: (1) a set number of iterations have been performed; (2) an amount of processing time has been reached; (3) convergence (e.g., the difference between consecutive iterations is less than a threshold value); (4) divergence (e.g., the performance deteriorates); (5) an acceptable outcome has been reached; and (6) all of the data has been processed.

3. Hardware Countermeasures

The root cause of the ciphertext side channel is the mode of encryption adopted in the XEX memory encryption that AMD uses in all its SEV versions (i.e., SEV, SEV-ES, and SEV-SNP) and all generations of CPUs (e.g., Zen, Zen 2, and Zen 3). This results from a well-known dilemma in the design of memory encryption: On one hand, if the ciphertext of each 16 blocks is chained together as, e.g., in the CBC mode encryption, the static mapping between ciphertext and plaintext can be broken. However, changing one bit in the plaintext will lead to changes in a large number of ciphertext blocks. On the other hand, if freshness is introduced [/, e.g., by updating each ciphertext block.?] to each block (like the CTR mode encryption used in Intel SGX), a large amount of memory needs to be reserved for storing the counter values. However, when freshness is applied only to selected memory regions, such as VMSA, the CipherLeaks attack against VMSA can be prevented. To our knowledge, the hardware patch that will be integrated in SEV-SNP takes a similar idea for protecting VMSA. However, the ciphertext side channel still exists in other memory regions.

a) VMSA Random Embodiments

In one or more embodiments, Cipherleak attacks may be mitigated (e.g., with the help of hardware) by introducing freshness to ciphertext blocks; specifically, by introducing randomness to the ciphertext blocks, such as in the VMSA where registers' values of SEV VM are stored. In this way, ciphertext of the same plaintext may be generated differently at different VMEXITs. As a result, an attacker cannot infer the registers' values stored in VMSA.

The following steps may be used in one or more embodiments: (1) Before hardware saves the registers' values in the VMSA during a VMEXIT, the hardware may generate one or more random numbers and protect them in a memory area where the software cannot reach or encrypt them. (2) Before saving the registers' values in the VMSA, the hardware may apply an XOR operation to registers' values and random numbers generated in step (1). Then the hardware may encrypt the result of the XOR operation and store the results in the VMSA. It is noted that the hardware may use any number of methods to add randomization when storing the registers' values as will be discussed further below. (3) When running VMRUN, the hardware may decrypt the data encrypted in step (2) and apply an XOR operation to the random number(s) from step (1). Therefore, the plaintext may be recovered and put back to the registers, and the VM may resume its regular operations. As a result, an attacker who attempts to steal the target function's return value stored in the VMSA RAX field can only obtain randomized ciphertext that is insufficient to infer plaintext therefrom, thus, successfully preventing a ciphertext side-channel attack.

In one or more embodiments, the hardware may store the random number in step (1) in a reserved area, e.g., while simultaneously restricting access from all software levels. In one or more embodiments, the random number in step (1) the hardware may choose to first encrypt the random number before storing it. The hardware should prevent software from accessing the key that is used to encrypt the random number and, in one or more embodiments, may be the same key that is used to encrypt the SEV-enabled VM.

Any number of randomization methods may be used during the XEX mode encryption when generating ciphertext. For example, the hardware may first XOR the random number with the plaintext to generate a result and XOR the result with the output of a tweak function. The result may then be XORed with the tweak function. In one example, the hardware may first XOR the output of the tweak function with the plaintext to generate a result. Then it may encrypt the result and XOR the encrypted result with the tweak function and, finally, XOR the result with the random number. As another example, the hardware may first XOR the output of the tweak function with the plaintext to generate a result. Then it may XOR the result with the random number and encrypt that result. That encrypted result may then be XORed with the tweak function before, finally, XORing that result with the random number.

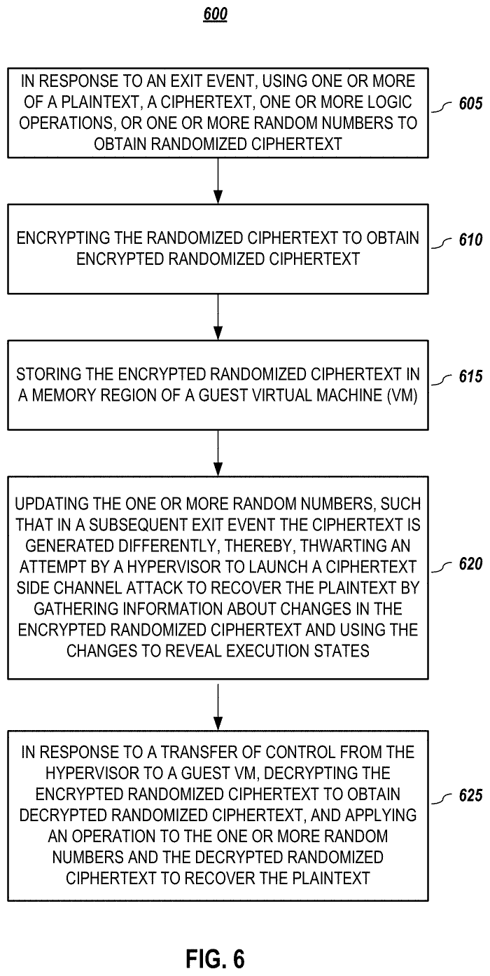

FIG. 6 is a flowchart illustrating a method for protecting against attacks by a compromised hypervisor, according to embodiments of the present disclosure. In one or more embodiments, the method for protecting against attacks may begin when, in response to an exit event, one or more of a plaintext, a ciphertext, one or more logic operations, or one or more random numbers are used (605) to obtain randomized ciphertext. The randomized ciphertext may be encrypted (610) to obtain encrypted randomized ciphertext, which may be stored (615) in a memory region of a guest VM. In one or more embodiments, the random number(s) may be updated (620), such that in a subsequent exit event the ciphertext is generated differently. As a result, an attempt by a hypervisor to launch a ciphertext side channel attack to recover the plaintext, e.g., by gathering information about changes in the encrypted randomized ciphertext and using the changes to reveal execution states may be thwarted. In one or more embodiments, decryption may follow a reverse order of steps.

One skilled in the art shall recognize that herein: (1) certain steps may optionally be performed; (2) steps may not be limited to the specific order set forth herein; (3) certain steps may be performed in different orders; and (4) certain steps may be done concurrently.

b) RMP Embodiments

One alternative hardware solution involves preventing a hypervisor from having read accesses to the guest VM's memory. In one or more embodiments, this may be implemented using the RMP table (see Section F), e.g., by restricting the hypervisor read access to guest pages. In detail, cipherleak attacks may be mitigated by using an RMP table as follows: In a first step, the owner of each memory page (e.g., a hypervisor or SEV VM) may be marked within an RMP entry. In a second step, when the hypervisor attempts to visit a page, hardware may perform a page table walk if there is a TLB miss. Each time after the hypervisor performs a page table walk, and before fetching the TLB entry, hardware may determine whether the owner of the memory page is the current user. If so, the TLB entry may be fetched; otherwise, a page fault may be triggered. In this way, hypervisors cannot visit pages that belong to an SEV VM or read the ciphertext in the VMSA. Since a hypervisor, thus, cannot monitor the ciphertext of register values in VMSA to infer the plaintext, the ciphertext side channel can be successfully mitigated.

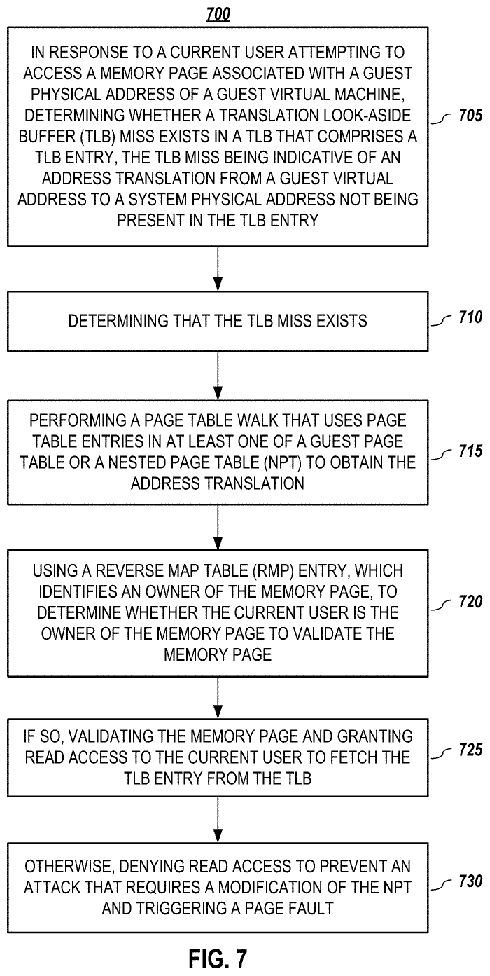

FIG. 7 is a flowchart illustrating a method for reducing leakage of confidential information from guest virtual memory registers, according to embodiments of the present disclosure.

In one or more embodiments, the method for reducing leakage may begin by determining (705), e.g., in response to a current user attempting to access a memory page associated with a guest physical address of a guest VM, whether a TLB miss exists. The TLB that may comprise a TLB entry, and the TLB miss may be indicative of an address translation from a guest virtual address to a system physical address not being present in the TLB entry.

In one or more embodiments, it may be determined (710) that the TLB miss exists, e.g., before performing (715) a page table walk that uses page table entries in at least one of a guest page table or an NPT to obtain the address translation. An RMP entry, which identifies an owner of the memory page, may be used (720) to determine whether the current user is the owner of the memory page to validate the memory page. If so, the memory page may be validated (725), and read access may be granted to the current user to fetch the TAB entry from the TLB. Otherwise, read access may be denied (730), e.g., to prevent an attack that requires a modification of the NPT and triggering a page fault.

F. Applicability to SEV-SNP

This section discusses some of the features of SEV-SNP and the applicability of CipherLeaks on SEV-SNP.

1. Overview of SEV-SNP

SEV-SNP protects guest VM's memory integrity by introducing RMPs. Each RMP entry is indexed by the system page frame numbers; it contains the page states (e.g., page's ownership, guest-valid, guest-invalid, and guest physical address) of this system page frame. The SEV-SNP VM must interact with the hypervisor to validate each RMP entry. Specifically, the guest VM needs to issue a new instruction PVALIDATE, a new instruction for guest VMs, to validate a guest physical address before the first access to that guest physical address. Any memory access to an invalid guest physical address will result in an NPF. More importantly, once a guest page is validated, the hypervisor cannot modify the RMP entry. Therefore, the guest VM itself can guarantee that its memory page is only validated once, and a one-to-one mapping between the guest physical address and system physical address mapping can be maintained.

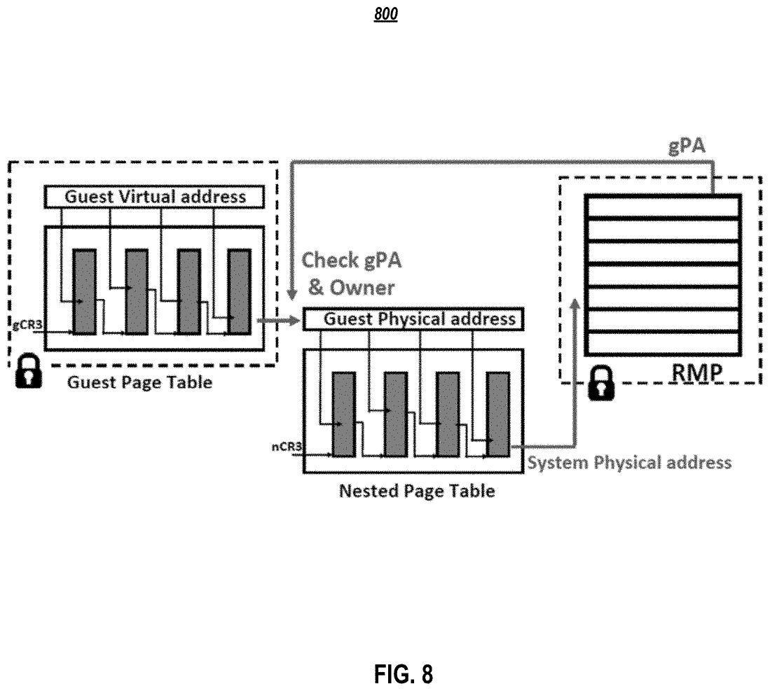

As shown in FIG. 8, which depicts an RMP check as used in various embodiments of the present disclosure, RMP limits the hypervisor's capabilities of managing NPT. The RMP check is performed before the NPT walk is finished. Without RMP check, the hypervisor may easily remap a guest physical address (_{g}PA) to an arbitrary memory page by manipulating the page table entry in the NPT. Using an RMP check, if the hypervisor remaps the guest physical address to a memory page that is not owned by the current guest VM or a memory page mapped to the current guest VM's other guest physical address, an invalid NPF or a mismatch NPF will be triggered, which may prevent attacks that require modification of the NPT.

Another protection enabled by RMP is that the ownership included in the RMP entry restricts the hypervisor's write permission towards the guest VM's private memory, which can prevent attacks that require directly modifying the ciphertext. More details about existing attacks and how RMP can mitigate these attacks are discussed in Section G.

2. The CipherLeaks Attack on SEV-SNP

There are two main requirements of the CipherLeaks attack:

(1) Mapping of plaintext-ciphertext pairs of the same address does not change. When applying the CipherLeaks attack to SEV-SNP, the memory encryption mode in SEV-SNP preserves the mapping between the plaintext and the ciphertext throughout the lifetime of the VM. SEV-SNP may still adopt the XEX mode of encryption.

(2) The hypervisor must have read access to the ciphertext. When applying the CipherLeaks attack the SEV-SNP, the adversary has read access to the ciphertext of guest VM's memory. Even though RMP may still limit the hypervisor's write access towards VM's private memory, the hypervisor still has read access to the guest VM's memory, including the VMSA.

G. Related Work

With the respect to an untrustworthy hypervisor, SEV has faced numerous attacks caused by unencrypted VMCB, unauthenticated encryption, unprotected NPT, unprotected I/O, and unauthorized key use. Such attacks successfully break the confidentiality and/or the integrity of SEV design. AMD patched SEV with additional features in the SEV-ES generation of processors.

Unencrypted VMCB. The VMCB is not encrypted during VMEXIT in SEV mode, which exposes SEV VM's registers state to the hypervisor. It has been shown that the untrusted hypervisor can manipulate guest VM's register during VMEXIT to perform return-oriented programming (ROP) attacks. It has also been shown that by continuously monitoring unencrypted VMCB, an adversary may fingerprint applications inside the guest VM and partially extract guest VM's memory. However, SEV-ES and SEV-SNP solve the unencrypted VMCB problem by encrypting most registers in the VMSA page during VMEXIT.

Unauthenticated encryption. The hypervisor can read and write the SEV/SEV-ES VM's memory because there is no authentication in these two modes. It has been shown that by reverse-engineering the physical address-based tweak function, an adversary may generate useful ciphertext when there are sufficient known plaintext-ciphertext pairs. However, EPYC™ processors after the EPYC™ 3xx1 series solved this problem by increasing the entropy of the tweak functions, which makes it practically impossible to reverse engineer the physical address-based tweak function. SEV-SNP further solved this problem by removing the hypervisor's write permission in the guest VM's memory.

Unprotected NPT. Address translation redirection attacks in SEV have been demonstrated and changing the guest VM's control flow have been considered, e.g., by remapping guest pages in the nPT. In a SEVered attack approach, an adversary extracts guest VM's memory by changing the memory mapping in some network-facing applications. The adversary first triggers some network requests and then changes the mapping of the guest physical address, which is supposed to contain network data before guest VM responding to the request. Thus, some wrong memory pages will be sent back, which leaks secrets to the adversary. SEV-SNP solved this problem by restricting unauthorized NPT remapping.

Unprotected I/O. Some approaches have exploited unprotected I/O in SEV and SEV-ES. It has been shown that SEV and SEV-ES rely on a shared region within a guest VM called Software I/O Translation Lookaside Buffer (SWIOTLB) to perform I/O read or write. This design allows the hypervisor to alter parts of I/O traffic, which helps to construct encryption and decryption oracles that can encrypt and decrypt arbitrary memory with the victim's VM encryption key (VEK). Even if SEV-SNP does not solve this unprotected I/O problem, the restriction of the hypervisor's write permission in SEV-SNP mitigates this attack.

ASID abuses. A series of attacks named CROSSLINE attacks exploit SEV's “Security-by-Crash” principle and Address Space Identify (ASID) management problem. ASID is used as an index of encryption keys in AMD firmware as well as TLB tags and cache tags. While the hypervisor is not considered trusted, SEV still leaves the ASID management to the hypervisor and relies on a “Security-by-Crash” principle where incorrect ASIDs always cause VM crashes to protect guest VM's integrity and confidentiality. In CROSSLINE attacks, the adversary is able to extract the guest VM's memory blocks, which conforms to the page table entry (PTE) format in a stealthy way. A CROSSLINE attack can succeed as long as the target VM's memory encryption key is not deactivated by the hypervisor, even if the victim VM is terminated. SEV-SNP did not change its ASID management design, but the ownership check restricts other software components from accessing the target VM's memory pages. Thus, CROSSLINE attacks cannot succeed in SEV-SNP.

Side-channel attacks. Architectural side channels such as cache side channels, performance counter tracking, or TLB side channels are common attacks in cloud computing. SEV's design increases the difficulty of performing some kinds of architectural side channels. For example, it is rather hard to perform a Flush+Reload attack when SEV is enabled. This is because cache lines are tagged with the VM's ASID, indicating to which VM this data belongs, thus, preventing the data from being misused by entities other than its owner. Since the cache is now tagged with ASID, cache coherence of the same physical address is not maintained if the two virtual memory pages do not have the same ASID and C-bit. Thus, although the malicious hypervisor can access the guest VM's arbitrary physical address, the hypervisor cannot directly determine whether the guest VM has accessed particular memory by measuring the time using the Flush+Reload method.

While being resistant to some architectural side channels, SEV is still vulnerable to page-fault side-channel attacks, in which the adversary monitors the page faults of the SEV-enabled VM to track its execution. In SEV mode, although the mapping between the guest VM's guest virtual address (gVA) to gPA is maintained by the guest VM's page table and encrypted by the VM Encryption Key, the hypervisor could still manipulate the NPT by clearing the P-bit to trap the translation from gPAs to system physical address (sPAs). Some approaches rely on this NPF side channel to identify memory pages containing web data. Some approaches use the page fault side channels to locate network buffer pages.

H. Some Conclusions

The ciphertext side channel on SEV processors, including SEV-ES and SEV-SNP, processors is discussed. The root causes of the side channel are two-fold: First, SEV uses XEX mode of encryption with a tweak function of the physical addresses, such that the one-to-one mapping between the ciphertext and plaintext of the same address is preserved. Second, the VM memory is readable by the hypervisor, allowing it to monitor the changes of the ciphertext blocks. It has been demonstrated that the CipherLeaks attack may exploit the ciphertext side-channel vulnerability to completely break the constant-time cryptography of OpenSSL when executed in SEV-ES VMs.

I. Computing System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smartphone, phablet, tablet, etc.), smartwatch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drive, solid state drive, or both), one or more network ports for communicating with external devices as well as various input and output (I/O) devices, such as a keyboard, mouse, touchscreen, stylus, microphone, camera, trackpad, display, etc. The computing system may also include one or more buses operable to transmit communications between the various hardware components.

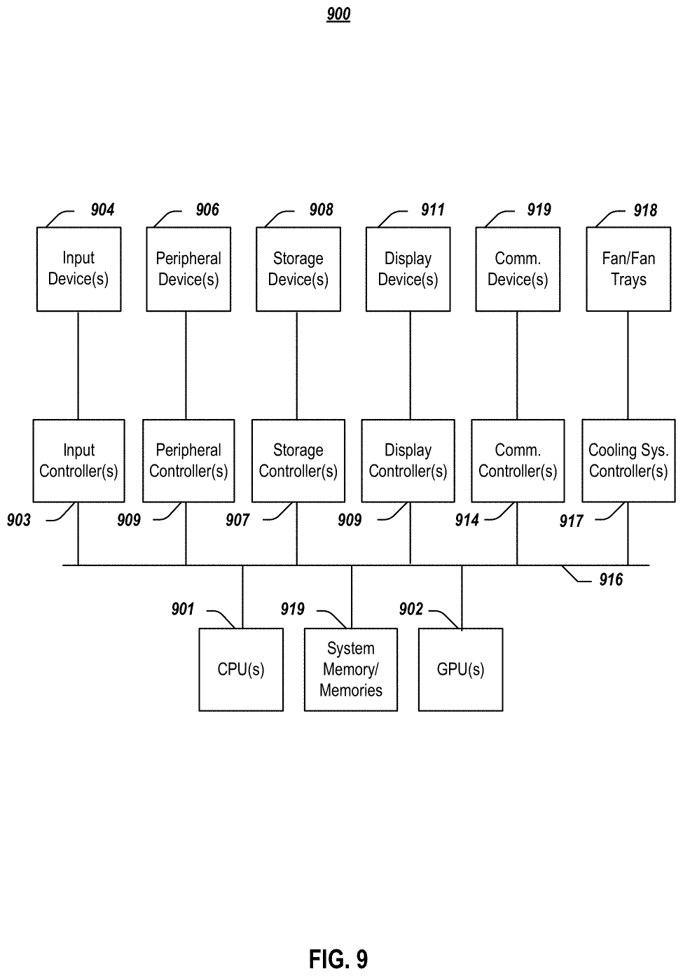

FIG. 9 depicts a simplified block diagram of an information handling system (or computing system), according to embodiments of the present disclosure. It will be understood that the functionalities shown for system 900 may operate to support various embodiments of a computing system—although it shall be understood that a computing system may be differently configured and include different components, including having fewer or more components as depicted in FIG. 9.

As illustrated in FIG. 9, the computing system 900 includes one or more CPUs 901 that provide computing resources and control the computer. CPU 901 may be implemented with a microprocessor or the like, and may also include one or more graphics processing units (GPU) 902 and/or a floating-point coprocessor for mathematical computations. In one or more embodiments, one or more GPUs 902 may be incorporated within the display controller 909, such as part of a graphics card or cards. Thy system 900 may also include a system memory 919, which may comprise RAM, ROM, or both.

A number of controllers and peripheral devices may also be provided, as shown in FIG. 9. An input controller 903 represents an interface to various input device(s) 904. The computing system 900 may also include a storage controller 907 for interfacing with one or more storage devices 908 each of which includes a storage medium such as magnetic tape or disk, or an optical medium that might be used to record programs of instructions for operating systems, utilities, and applications, which may include embodiments of programs that implement various aspects of the present disclosure. Storage device(s) 908 may also be used to store processed data or data to be processed in accordance with the disclosure. The system 900 may also include a display controller 909 for providing an interface to a display device 911, which may be a cathode ray tube (CRT) display, a thin film transistor (TFT) display, organic light-emitting diode, electroluminescent panel, plasma panel, or any other type of display. The computing system 900 may also include one or more peripheral controllers or interfaces 905 for one or more peripherals 906. Examples of peripherals may include one or more printers, scanners, input devices, output devices, sensors, and the like. A communications controller 914 may interface with one or more communication devices 915, which enables the system 900 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 900 comprises one or more fans or fan trays 918 and a cooling subsystem controller or controllers 917 that monitors thermal temperature(s) of the system 900 (or components thereof) and operates the fans/fan trays 918 to help regulate the temperature.

In the illustrated system, all major system components may connect to a bus 916, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

Aspects of the present disclosure may be encoded upon one or more non-transitory computer-readable media with instructions for one or more processors or processing units to cause steps to be performed. It shall be noted that non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magneto-optical media; and hardware devices that are specially configured to store or to store and execute program code, such as ASICs, PLDs, flash memory devices, other non-volatile memory devices (such as 3D XPoint-based devices), and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A computer-implemented method for reducing leakage of confidential information from guest virtual machine (VM) registers, the method comprising:
in response to a current user attempting to access a memory page associated with a guest physical address of a guest VM, determining whether a Translation Look-aside Buffer (TLB) miss exists in a TLB that comprises a TLB entry, the TLB miss being indicative of an address translation from a guest virtual address to a system physical address not being present in the TLB entry; and
in response to determining that the TLB miss exists, using one or more processors to perform steps comprising:
performing a page table walk that uses page table entries in at least one of a guest page table or a nested page table (NPT) to obtain the address translation;
using a Reverse Map Table (RMP) entry, which identifies an owner of the memory page, to determine whether the current user is the owner of the memory page to validate the memory page;
in response to determining that the current user is the owner of the memory page, validating the memory page and granting read access to the current user to fetch the TLB entry from the TLB; and
otherwise, denying read access to prevent an attack that requires a modification of the NPT and triggering a page fault.

2. The method according to claim 1, wherein the modification comprises remapping of an entry in the NPT comprising the guest physical address to at least one of a memory page not associated with the current guest VM.

3. The method according to claim 1, wherein validating the memory page comprises the guest VM, in response to receiving an instruction to validate the guest physical address, interacts with a hypervisor to validate the RMP entry.

4. The method according to claim 3, wherein the memory page is validated prior to granting access to the guest physical address in the NPT to prevent the current user from modifying the RMP entry, thereby, maintaining a one-to-one mapping between the guest physical address and the system physical address.

5. The method according to claim 3, further comprising preventing the hypervisor from reading ciphertext in a memory region of the guest VM that comprises register values in a VM Save Area (VMSA) to infer plaintext therefrom.

6. The method according to claim 3, wherein the RMP entry is indexed by one or more system page frame numbers.

7. The method according to claim 3, wherein the RMP entry identifies the owner using at least one page state that comprises page ownership information.

8. The method according to claim 1, further comprising, in response to determining that the TLB miss does not exist, using the TLB entry to translate the guest virtual address to the system physical address without performing the page table walk.

9. A system for reducing leakage of confidential information from guest virtual machine (VM) registers, the system comprising:
one or more processors; and
a non-transitory computer-readable medium or media comprising one or more sets of instructions which, when executed by at least one of the one or more processors, causes steps to be performed comprising:
in response to a current user attempting to access a memory page associated with a guest physical address of a guest VM, determining that a Translation Look-aside Buffer (TLB) miss exists in a TLB that comprises a TLB entry, the TLB miss being indicative of an address translation from a guest virtual address to a system physical address not being present in the TLB entry;
performing a page table walk that uses page table entries in at least one of a guest page table or a nested page table (NPT) to obtain the address translation;
using a Reverse Map Table (RMP) entry, which identifies an owner of the memory page, to determine whether the current user is the owner of the memory page to validate the memory page;
in response to determining that the current user is the owner of the memory page, validating the memory page and granting read access to the current user to fetch the TLB entry from the TLB; and
in response to determining that the TLB miss does not exist, denying read access to prevent an attack that requires a modification of the NPT and triggering a page fault.

10. The method according to claim 9, further comprising preventing a hypervisor from reading ciphertext in a memory region of the guest VM that comprises register values in a VM Save Area (VMSA) to infer plaintext therefrom.

11. The system according to claim 9, wherein the memory page is validated prior to granting access to the guest physical address in the NPT to prevent the current user from modifying the RMP entry, thereby, maintaining a one-to-one mapping between the guest physical address and the system physical address.

12. The system according to claim 11, wherein the RMP entry is indexed by one or more system page frame numbers and identifies the owner using at least one page state that comprises page ownership information.

13. The system according to claim 11, wherein the RMP entry identifies the owner using at least one page state that comprises page ownership information.

14. The system according to claim 9, further comprising, caching the address translation in the TLB entry for use in a subsequent access to the guest virtual address.

15. The system according to claim 9, further comprising, in response to obtaining the address translation, saving the address translation in the TLB.

16. The system according to claim 9, wherein the system physical address comprises a DRAM address.

17. A non-transitory computer-readable medium or media comprising one or more sequences of instructions which, when executed by at least one processor, causes steps for reducing leakage of confidential information from guest virtual machine (VM) registers comprising:
in response to a current user attempting to access a memory page associated with a guest physical address of a guest VM, determining whether a Translation Look-aside Buffer (TLB) miss exists in a TLB that comprises a TLB entry, the TLB miss being indicative of an address translation from a guest virtual address to a system physical address not being present in the TLB entry; and
in response to determining that the TLB miss exists, using one or more processors to perform steps comprising:
performing a page table walk that uses page table entries in at least one of a guest page table or a nested page table (NPT) to obtain the address translation;
using a Reverse Map Table (RMP) entry, which identifies an owner of the memory page, to determine whether the current user is the owner of the memory page to validate the memory page;
in response to determining that the current user is the owner of the memory page, validating the memory page and granting read access to the current user to fetch the TLB entry from the TLB; and
otherwise, denying read access to prevent an attack that requires a modification of the NPT and triggering a page fault.

18. The non-transitory computer-readable medium or media according to claim 17, wherein the memory page is validated prior to granting access to the guest physical address in the NPT to prevent the current user from modifying the RMP entry, thereby, maintaining a one-to-one mapping between the guest physical address and the system physical address.

19. The non-transitory computer-readable medium or media according to claim 17, further comprising preventing the hypervisor from reading ciphertext in a memory region of the guest VM that comprises register values in a VM Save Area (VMSA) to infer plaintext therefrom.

20. The non-transitory computer-readable medium or media according to claim 17, wherein the RMP entry is indexed by one or more system page frame numbers and identifies the owner using at least one page state that comprises page ownership information.
